(19) United States
(12) Patent Application Publication
(10) Pub. No.: US 2026/0292811 A1
(43) Pub. Date: Sep. 24, 2026

(54) METHODS AND DEVICES FOR DETERMINING UE AGGREGATION TRANSMISSION

(71) Applicant: ZTE CORPORATION, Shenzhen, Guangdong (CN)

(72) Inventors: Wei GOU, Shenzhen (CN); Xianghui HAN, Shenzhen (CN); Shuaihua KOU, Shenzhen (CN); Jing SHI, Shenzhen (CN)

(21) Appl. No.: 19/476,464

(22) PCT Filed: May 24, 2023
(86) PCT No.: PCT/CN2023/096062

§ 371 Date: Oct. 17, 2025

(51) Int. Cl. H04W 72/121; H04W 72/21

(52) U.S. Cl. CPC H04W 72/121; H04W 72/21

(57) ABSTRACT

The present disclosure describes methods, system, and devices for determining user equipment (UE) aggregation transmission. transmission. A method for wireless communication, including: determining user equipment (UE) aggregation transmission, where a first UE and a second UE are paired for the UE aggregation transmission, by: reporting paired information to a base station; and reporting relevant information to the base station.

### CROSS-REFERENCE TO RELATED APPLICATION(S)

This application is a national phase entry under 35 USC 371 of International Patent Application No. PCT/CN 2023/096062 filed on May 24, 2023, and the entire content of the International Patent Application is incorporated into this application by reference.

### TECHNICAL FIELD

The present disclosure is directed generally to wireless communications. Particularly, the present disclosure relates to methods and devices for determining user equipment (UE) aggregation transmission.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

### SUMMARY

In one embodiment, the present disclosure describes a method for wireless communication. The method includes determining user equipment (UE) aggregation transmission, wherein a first UE and a second UE are paired for the UE aggregation transmission, by: reporting paired information to a base station; and reporting relevant information to the base station.

In one embodiment, the present disclosure describes a method for wireless communication. The method includes configuring user equipment (UE) aggregation transmission, wherein a first UE and a second UE are paired for the UE aggregation transmission, by: receiving paired information by a base station; and receiving relevant information by the base station.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods. The computer-readable medium includes a non-transitory computer-readable medium.

The above and other aspects and their implementations are described in greater detail in the drawings, the descriptions, and the claims.

### BRIEF DESCRIPTION OF THE DRAWINGS

FIG. 1 shows an example of a wireless communication system include one wireless network node and one or more user equipment.

FIG. 2 shows an example of a network node.

FIG. 3 shows an example of a user equipment.

FIG. 4A shows a flow diagram of an exemplary method for wireless communication.

FIG. 4B shows a flow diagram of another exemplary method for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for determining UE aggregation transmission.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfil the requirements from different industries and users.

In some wireless communication schemes, user equipment (UE) aggregation transmission may be used to improve throughout or reliability of transmission from a UE, for example, when the UE is at a cell edge of a base station. There are many problems/issues associated with operations of UE aggregation transmission. For example, one problem/issue may include how to report paired information of the UE aggregation transmission; another problem/issue may include how to report relevant information of the UE aggregation transmission.

The present disclosure describes various embodiments for determining UE aggregation transmission, addressing at least one of the issues/problems discussed above, improving performance of the wireless communication, particularly achieving efficient transmission of UE aggregation transmission and improving throughput and/or reliability of UE's transmission.

In some implementations, the UE aggregation transmission may be divided into a plurality of modes, for example, a transparent mode and a non-transparent mode. In the transparent mode, the base station may be unaware that a group of UEs (e.g., a first UE (UE1) and a second UE (UE2)) are paired for UE aggregation transmission. In the non-transparent mode, the base station knows that the group of UEs are paired for UE aggregation transmission, and knows that one UE's data may be transmitted by another UE, for example, the base station may know that the UE1's data may be transmitted by the UE2.

In some implementations, transparent mode may have some drawbacks that lead to inefficiency. For one non-limiting example, a channel environment (such as channel state information (CSI), interference, etc.) of the UE1 and the UE2 may be different. The base station may not be aware that the UE1 and the UE2 are paired to perform the UE aggregation transmission, and thus, the base station may always configure parameter values in the UE1's uplink (UL) grant based on the UE1's channel environment. The UE1's data is ultimately transmitted by the UE2 based on the UE2's channel environment. Obviously, in this case, when the UE1's data is transmitted by the UE2, the parameters matching UE2's channel environment are not used and it may lead to inefficiency.

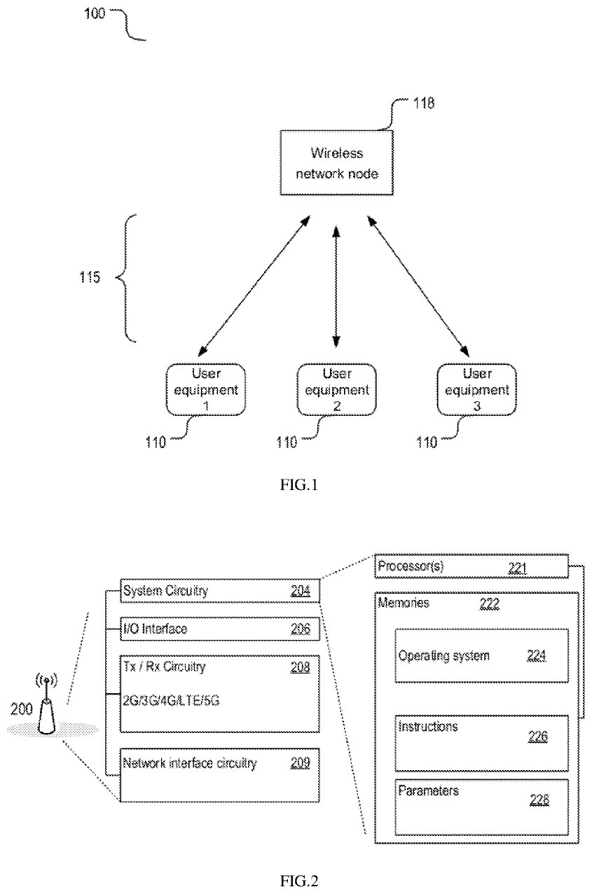

FIG. 1 shows a wireless communication system 100 including a wireless network node 118 and one or more user equipment (UE) 110. The wireless network node may include a network base station, which may be a nodeB (NB, e.g., a gNB) in a mobile telecommunications context. Each of the UE may wirelessly communicate with the wireless network node via one or more radio channels 115 for downlink/uplink communication. For example, a first UE 110 may wirelessly communicate with a wireless network node 118 via a channel including a plurality of radio channels during a certain period of time. The network base station 118 may send high layer signaling to the UE 110. The high layer signaling may include configuration information for communication between the UE and the base station. In one implementation, the high layer signaling may include a radio resource control (RRC) message.

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

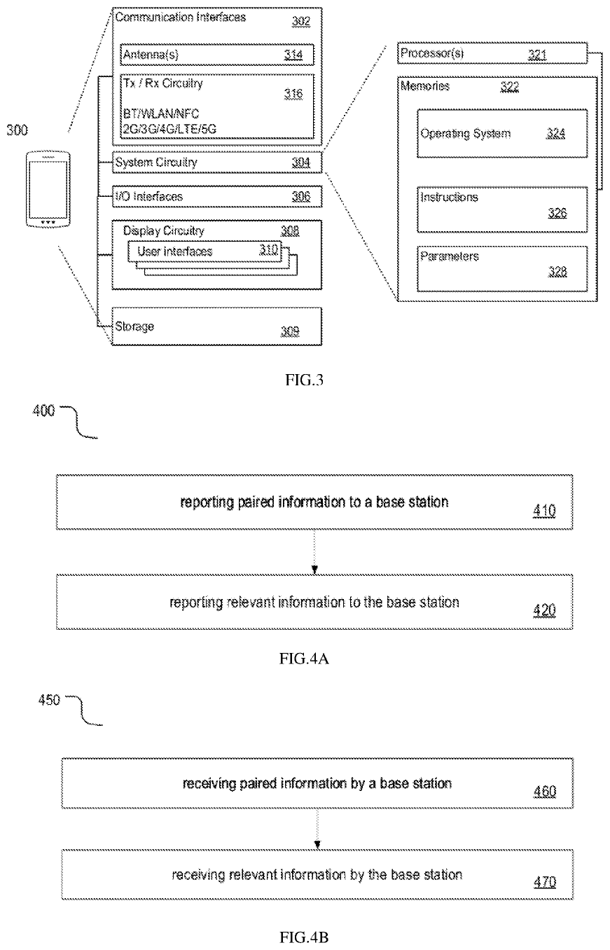

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP 2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for determining UE aggregation transmission, which may be implemented, partly or totally, on the network base station and/or the user equipment described above in FIGS. 2-3.

In various embodiments in the present disclosure, when a group of UEs are in UE aggregation transmission, each UE in the group may have its role type.

For one non-limiting example, when a first UE (UE1) and a second UE (UE2) are paired for UE aggregation transmission, the UE1's data is transmitted to the base station by the UE2, and the UE2's data is not transmitted to the base station by the UE1, the UE1and the UE2 may represent different role types: the UE1 may have a role type of an anchor UE and the UE2 may have a role type of an assistant UE. In some implementations, the UE1's data may include UE1's uplink control information (UCI), for example, hybrid automatic repeat request acknowledgement (HARQ-ACK), scheduling request (SR), channel state information (CSI), etc.

For another non-limiting example, when a first UE (UE1) and a second UE (UE2) are paired for UE aggregation transmission, the UE1's data is transmitted to the base station by the UE2, and the UE2's data is transmitted to the base station by the UE1, the UE1 and the UE2 may represent a role type of mutual UEs: the UE1 may have a role type of an anchor UE and a role type of an assistant UE; and the UE2 may have a role type of an assistant UE and a role type of an anchor UE. In some implementations, the UE1's data may include UE1's uplink control information (UCI), for example, hybrid automatic repeat request acknowledgement (HARQ-ACK), scheduling request (SR), channel state information (CSI), etc. ; and the UE2's data may include UE2's uplink control information (UCI), for example, hybrid automatic repeat request acknowledgement (HARQ-ACK), scheduling request (SR), channel state information (CSI), etc.

In various embodiments, the anchor UE and the assistant UE may be called as master UE and slave UE, respectively, or primary UE and secondary UE, respectively.

In various embodiments, in order to support UE aggregation transmission (for example, non-transparent UE aggregation transmission, wherein the UE aggregation transmission is controlled by the base station), some methods for transmitting data and/or signaling between the base station and paired UEs (UE1 and UE2) are described. In some implementations, a UE1 and a UE2 are paired to perform UE aggregation transmission, and the UE1's data (including uplink control information) is transmitted to the base station by the UE2; the paired information may be reported to the base station; relevant information on UE aggregation transmission may be interacted with the base station and the specific method of UE aggregation transmission may be determined; and the UE aggregation transmission based on configured parameters in the configured resources may be executed.

Referring to FIG. 4A, the present disclosure describes various embodiments of a method 400 for wireless communication including determining user equipment (UE) aggregation transmission, wherein a first UE and a second UE are paired for the UE aggregation transmission. The method 400 may include a portion or all of the following steps: step 410, reporting paired information to a base station; and step 420, reporting relevant information to the base station.

Referring to FIG. 4B, the present disclosure describes various embodiments of a method 450 for wireless communication for configuring user equipment (UE) aggregation transmission, wherein a first UE and a second UE are paired for the UE aggregation transmission. The method 450 may include a portion or all of the following steps: step 460, receiving paired information by a base station; and step 470, receiving relevant information by the base station.

In some implementations, in addition to a portion, an entire, or any combination of the described implementation(s)/embodiment(s), the second UE is determined to transmit the first UE's data to the base station, the first UE's data comprising uplink control information (UCI), for example, including hybrid automatic repeat request acknowledgement (HARQ-ACK), scheduling request (SR), channel state information (CSI), etc.

In some implementations, in addition to a portion, an entire, or any combination of the described implementation(s)/embodiment(s), the reporting the paired information to the base station comprises: reporting, by the second UE, the paired information to the base station, the paired information comprising an identifier of the first UE, so that the base station is configured to determine that the second UE transmits the first UE's data to the base station.

In some implementations, in addition to a portion, an entire, or any combination of the described implementation(s)/embodiment(s), the reporting the paired information to the base station comprises: reporting, by the first UE, the paired information to the base station, the paired information comprising an identifier of the second UE, so that the base station is configured to determine that the second UE transmits the first UE's data to the base station.

In some implementations, in addition to a portion, an entire, or any combination of the described implementation(s)/embodiment(s), the reporting the paired information to the base station comprises: reporting, by each of the first UE and the second UE, the same paired information to the base station with same coding and same modulation in the same resource, the paired information comprising identifiers of the first UE and the second UE, so that the base station is configured to determine that the second UE transmits the first UE's data to the base station.

In some implementations, in addition to a portion, an entire, or any combination of the described implementation(s)/embodiment(s), the reporting the paired information to the base station comprises: reporting, by each of the first UE and the second UE, the same paired information to the base station with same coding and same modulation in different resource, the paired information comprising identifiers of the first UE and the second UE, so that the base station is configured to determine that the second UE transmits the first UE's data to the base station.

In some implementations, in addition to a portion, an entire, or any combination of the described implementation(s)/embodiment(s), the reporting the paired information to the base station comprises: reporting, by at least one of the first UE and the second UE, the paired information to the base station configured by a signalling from the base station, the signaling comprising at least one of the following: a radio resource control (RRC) signalling or a medium access control (MAC) control element (CE).

In some implementations, in addition to a portion, an entire, or any combination of the described implementation(s)/embodiment(s), the method 400 may further include reporting, by at least one of the first UE and the second UE, a UE capability of reporting the paired information to the base station, so that the base station is configured to consider the UE having the UE capability to report the paired information.

In some implementations, in addition to a portion, an entire, or any combination of the described implementation(s)/embodiment(s), the paired information comprises at least one of the following: an identification of the UE performing the UE aggregation transmission, or a role type of the UE performing the UE aggregation transmission.

In some implementations, in addition to a portion, an entire, or any combination of the described implementation(s)/embodiment(s), there may be a few scenarios. For one scenario: there may be an identification bit in the pairing information, which is used to mark whether the paired UE is an anchor UE and an assistant UE. When indicating the anchor UE and the assistant UE for each other, a flag may be set to 1, otherwise it is set to 0. In some implementations, the indication for UE1 and UE2 may be required.

For another scenario: the pairing information includes the role type of the UE. When indicating the anchor UE and the assistant UE for each other, the role of the UE1 is set as “both”, indicating that it is both an anchor UE and an assistant UE, and the role of the UE2 is also set to both.

In some implementations, when it is not the case of anchor UE and assistant UE, the role of the UE1 is anchor UE, and the role of the UE2 is assistant UE.

In some implementations, in addition to a portion, an entire, or any combination of the described implementation(s)/embodiment(s), the role type of the UE performing the UE aggregation transmission comprises at least one of the following: an anchor UE, an assistant UE, or a mutual UE; wherein in response to the second UE being determined to transmit the first UE's data to the base station and the first UE being determined not to transmit the second UE's data to the base station, the first UE is the anchor UE and the second UE is the assistant UE; and/or wherein in response to the second UE being determined to transmit the first UE's data to the base station, and the first UE also being determined to transmit the second UE's data to the base station, the first UE and the second UE are mutual UEs. In some implementations, a UE having a mutual UE type may indicate that the UE can serve as an anchor UE type (i.e., its data is transmitted to the base station by another UE) and can serve as an assistant UE type (i.e., it can transmit another UE's data to base station).

In some implementations, in addition to a portion, an entire, or any combination of the described implementation(s)/embodiment(s), the paired information comprises at least one of the following: an identification of the UE performing the UE aggregation transmission, a role type of the UE performing the UE aggregation transmission, or an indication for anchor UE and assistant UE each other.

In some implementations, in addition to a portion, an entire, or any combination of the described implementation(s)/embodiment(s), the reporting the relevant information to the base station comprises: reporting, by the second UE, the relevant information to the base station, the relevant information comprising information of the first UE and the second UE.

In some implementations, in addition to a portion, an entire, or any combination of the described implementation(s)/embodiment(s), the reporting the relevant information to the base station comprises: reporting, by the first UE, the relevant information to the base station, the relevant information comprising information of the first UE and the second UE.

In some implementations, in addition to a portion, an entire, or any combination of the described implementation(s)/embodiment(s), the reporting the relevant information to the base station comprises: reporting, by each of the first UE and the second UE, the same relevant information to the base station with same coding and same modulation in the same resource, so that the base station is configured to decode the relevant information.

In some implementations, in addition to a portion, an entire, or any combination of the described implementation(s)/embodiment(s), the reporting the relevant information to the base station comprises: reporting, by each of the first UE and the second UE, the same relevant information to the base station with same coding and same modulation in different resource, so that the base station is configured to decode the relevant information.

In some implementations, in addition to a portion, an entire, or any combination of the described implementation(s)/embodiment(s), the reporting the relevant information to the base station comprises: reporting, by each of the first UE and the second UE, different relevant information to the base station, so that the base station is configured to decode the relevant information from the received different relevant information.

In some implementations, in addition to a portion, an entire, or any combination of the described implementation(s)/embodiment(s), the reporting the relevant information to the base station comprises: reporting, by at least one of the first UE and the second UE, the relevant information to the base station configured by a signalling from the base station, the signaling comprising at least one of the following: a radio resource control (RRC) signalling or a medium access control (MAC) control element (CE).

In some implementations, in addition to a portion, an entire, or any combination of the described implementation(s)/embodiment(s), the method 400 may further include reporting, by at least one of the first UE and the second UE, a UE capability of reporting the relevant information to the base station, so that the base station is configured to consider the UE having the UE capability to report the relevant information.

In some implementations, in addition to a portion, an entire, or any combination of the described implementation(s)/embodiment(s), the relevant information comprises at least one of the following: a channel state information (CSI) report of the first UE, a CSI report of the second UE, a beam information of the first UE for transmission or reception, a beam information of the second UE for transmission or reception, a hybrid automatic repeat request acknowledgement (HARQ-ACK) information of the first UE, a HARQ-ACK information of the second UE, a UE aggregation transmission mode requested by the first UE, a UE aggregation transmission mode requested by the second UE, a multiple-input multiple-output (MIMO) information of the first UE for transmission or reception, a MIMO information of the second UE for transmission or reception, a measurement report of the first UE for interference, a measurement report of the second UE for interference, a measurement report of the first UE for adjacent cells, a measurement report of the second UE for adjacent cells, a measurement report of the first UE for adjacent frequencies, a measurement report of the second UE for adjacent frequencies, a measurement report of the first UE for same frequency, a measurement report of the second UE for same frequency, a measurement report of the first UE for reference signals received power (RSRP) or reference signals received quality (RSRQ), a measurement report of the second UE for RSRP or RSRQ, an antenna port information of the first UE for transmission or reception, or an antenna port information of the second UE for transmission or reception.

In some implementations, in addition to a portion, an entire, or any combination of the described implementation(s)/embodiment(s), the base station configures at least one of the following: a mode of the UE aggregation transmission, or transmission information for the UE aggregation transmission having the mode.

In some implementations, in addition to a portion, an entire, or any combination of the described implementation(s)/embodiment(s), the mode comprises at least one of the following: a single frequency network (SFN) mode, a time division modulation (TDM) mode, a frequency division modulation (FDM) mode, a space division mode, or a code division mode; and/or the transmission information comprises at least one of the following: a timing advance for the UE aggregation transmission, an offset of the timing advance, or power information.

In some implementations, in addition to a portion, an entire, or any combination of the described implementation(s)/embodiment(s), the first UE requests its mode of the UE aggregation transmission; and/or the second UE requests its mode of the UE aggregation transmission.

In some implementations, in addition to a portion, an entire, or any combination of the described implementation(s)/embodiment(s), the reporting the paired information to the base station comprises: reporting, by the first UE, the paired information to the base station, the paired information indicating the first UE being paired with other UE without an identifier of the other UE; and/or the reporting the relevant information to the base station comprises: reporting, by the first UE, the relevant information to the base station, the relevant information comprising information of the first UE and information of the second UE; and/or the base station is configured to schedule transmission of the first UE based on the relevant information.

The present disclosure describes various embodiments for reporting the paired information to the base station based on at least one of the following methods. In various implementations in the present disclosure, a group of paired UEs for UE aggregation transmission may include a first UE (UE1) and a second UE (UE2); and the UE1 may be an anchor UE and the UE2 may be an assistant UE, wherein the UE2 transmits the UE1's data to the base station.

For one method (Method A1), the base station and the group of UEs may agree that, among the paired UEs, the UE2 reports the paired information to the base station. That is to say, in UE aggregation transmission, the assistant UE reports the paired information to the base station. In this way, when the base station receives the paired information from a UE, it may directly determine that the UE is an assistant UE. The base station may determine the corresponding anchor UE based on the identification of the UE in the received paired information. In this way, the paired information may only contain the identification of the anchor UE, in order to reduce signaling overhead.

For another method (Method A2), the base station and the group of UEs may agree that, among the paired UEs, the UE1 reports the paired information to the base station. That is, in UE aggregation transmission, the anchor UE reports the paired information to the base station. In this way, when the base station receives the paired information from a UE, it may directly determine that the UE is an anchor UE. The base station may determine the corresponding assistant UE based on the identification of the UE in the received paired information. In this way, the paired information may only contain the identification of the assistant UE, in order to reduce signaling overhead.

For another method (Method A3), the UE1 and the UE2 may respectively report the paired information to the base station. This method is suitable for situations where both UE1 and UE2 are located in poor channel environments (such as cell edges). In some implementations, the UE1 and the UE2 may report the same bits of the paired information to the base station (and use the same coding and modulation for the paired information). The base station jointly decodes the paired information received from the UE1 and the UE2 to improve reliability. In this way, the paired information contains the identifiers of the UE1and the UE2, and indicates the types of the UE1 and the UE2 (for example, the UE1 is an anchor UE and the UE2 is an assistant UE). In this way, based on the received paired information, the base station determines that the UE1 and the UE2 are paired and that the UE1 is an anchor UE and the UE2 is an assistant UE. In some other implementations, the bits of the paired information reported by the UE1 and the UE2 can also be different. For example, in the bits of the paired information reported by the UE1, the identifier of the UE1 is placed before the identifier of the UE2. In the bits of the paired information reported by the UE2, the identifier of the UE1 is placed after the identifier of the UE2. In this way, joint decoding cannot be used well, but it still works.

For another method (Method A4), the base station configures the reporting mode of the paired information through signaling (such as RRC signaling or MAC CE). For example, the base station configures the paired information to be reported by the UE1 and/or the UE2, i.e., by an anchor UE and/or an assistant UE.

For another method (Method A5), a UE capability may be introduced to describe that a UE has (or does not have) the ability to report the paired information. That is to say, when a UE reports that it has the aforementioned capability, the base station considers that the UE can be configured to report the paired information; Otherwise, the UE cannot be configured to report the paired information. When all paired UEs have the aforementioned capability, the base station and the group of UE may agree to report the paired information based on any one or combination of Methods A1, A2, A3, and/or A4.

The present disclosure describes various embodiments, wherein the paired information contains at least one of the following: the identification of the UE performing the UE aggregation transmission (such as the identification of the UE1 and/or the identification of the UE2), and/or the type of UE performing the UE aggregation transmission (for example, the UE1 is the assistant UE or the anchor UE, and/or the UE2 is the assistant UE or the anchor UE). In some implementations, some of the above information may be implied, not explicitly included in the paired information. For a non-limiting example, in Method A1 above, the identification of the UE2 and the type of the UE2 are not included in the paired information, and the UE2 can be known to be an assistant UE by agreeing that the assistant UE reports the paired information. The identification of the UE2 can be determined to be the identification of the UE that reported the paired information.

The present disclosure describes various embodiments, wherein the paired UE1 and UE2 are each other's assistant UE and anchor UE, i.e., “mutual” UE. When the UE1 and the UE2 are paired, the UE1 can transmit the UE2's data, and the UE2 can also transmit the UE1's data. In response to this situation, the paired information should indicate that UE1 and UE2 are each other's assistant UE and anchor UE (or mutual UE), such as through explicit parameter indication or implicit signaling structures.

In some implementations, for an example in the Method A1, when the UE1 and the UE2 are each other's assistant UE and anchor UE, the paired information reported by the UE2 further includes an indication that the UE1 and the UE2 are each other's assistant UE and anchor UE.

In some implementations, for an example in the Method A2, when the UE1 and the UE2 are each other's assistant UE and anchor UE, the paired information reported by the UE1 further includes an indication that the UE1 and the UE2 are each other's assistant UE and anchor UE.

In some implementations, for an example in the Method A3, when the UE1 and the UE2 are each other's assistant UE and anchor UE, the paired information reported by the UE1 and the UE2 further includes an indication that the UE1 and the UE2 are each other's assistant UE and anchor UE.

In some implementations, for any or all of the above Method A1-A5, in order to reduce signaling overhead, the base station and the group of UEs may also agree that when the paired information does not include the type of UE performing UE aggregation transmission, it indicates that the paired UEs are each other's assistant UE and anchor UE. For a non-limiting example, in Method A3, when the paired information does not contain parameter indication that the UE1 and the UE2 are each other's assistant UE and anchor UE, the base station and the group of UEs consider the UE1 and the UE2 in the paired information to be each other's assistant UE and anchor UE, and vice versa.

The present disclosure describes various embodiments for reporting relevant information for UE aggregation transmission based on at least one of the following methods. In various implementations in the present disclosure, a group of paired UEs for UE aggregation transmission may include a first UE (UE1) and a second UE (UE2); and the UE1 may be an anchor UE and the UE2 may be an assistant UE, wherein the UE2 transmits the UE1's data to the base station.

For one method (Method B1), the base station and the UE agree that in the paired UEs, the UE2 reports the relevant information to the base station. That is, the assistant UE reports the relevant information to the base station. In this way, when the base station receives the relevant information from the UE2, the base station can obtain the relevant information of the UE1 and the UE2. That is, the relevant information reported by the UE2 contains both the relevant information of the UE1 and UE2.

For another method (Method B2), the base station and the UE agree that in the paired UEs, the UE1 reports the relevant information to the base station. That is, the anchor UE reports the relevant information to the base station. Thus, when the base station receives the relevant information from the UE1, the base station can determine the relevant information of the UE1 and the UE2 from the relevant information reported by the UE1. That is, the relevant information reported by the UE1 contains both the relevant information of the UE1 and UE2.

For another method (Method B3), the UE1 and UE2 respectively report the same relevant information to the base station. This method is suitable for situations where both the UE1 and the UE2 are located in poor channel environments (such as cell edges). For example, the UE1 and UE2 each report the same bits of relevant information (and use the same coding and modulation for the relevant information), so that the base station can jointly decode the relevant information received from the UE1 and UE2, in order to improve reliability.

For another method (Method B4), the UE1 and UE2 respectively report the different relevant information to the base station. This method is suitable for situations where both the UE1 and UE2 are located in poor channel environments (such as cell edges). For example, the UE1 and UE2 each report the different bits of relevant information. For example, in the bits of relevant information reported by the UE1, the identifier of the UE1 is placed before the identifier of the UE2. In the bits of relevant information reported by the UE2, the identifier of the UE1 is placed after the identifier of the UE2. In this way, the performance of joint decoding may decrease, but it still works.

For another method (Method B5), the base station configures the reporting mode of the relevant information through signaling (such as RRC signaling or MAC CE). For example, the base station configures the relevant information to be reported by the UE1 and/or the UE2, i.e., by the anchor UE and/or the assistant UE.

For another method (Method B6), a UE capability is introduced to describe that a UE has (or does not have) the ability to report the relevant information. That is to say, when a UE reports that it has the aforementioned capability, the base station considers that the UE can be configured to report the relevant information; otherwise, the UE cannot be configured to report the relevant information. When all paired UEs have the aforementioned capability, the base station and UE agree to report the relevant information based on the above Methods B1-B5.

The present disclosure describes various embodiments, wherein the relevant information mentioned above includes at least one of the following: CSI reports of the UE1 and/or UE2, beam information of the UE1 and/or UE2 for transmission/reception, HARQ-ACK information of the UE1 and/or UE2, UE aggregation transmission mode requested by the UE1 and/or UE2, MIMO information of the UE1 and/or UE2 for transmission/reception, measurement reports of the UE1 and/or UE2 for interference, measurement reports of the UE1 and/or UE2 for adjacent cells, measurement reports of the UE1 and/or UE2 for adjacent frequencies, measurement reports of the UE1 and/or UE2 for same frequency, measurement reports of the UE1 and/or UE2 for RSRP/RSRQ, antenna port information of the UE1 and/or UE2 for transmission/reception (such as the number of supported antenna ports).

The present disclosure describes various embodiments, wherein the base station may configure the mode or purpose of UE aggregation transmission through signaling (such as RRC signaling, MAC CE or DCI signaling). For example, the base station may configure the UE1 and the UE2 to perform UE aggregation transmission according to one aggregation transmission mode. In the present disclosure, the mode of UE aggregation transmission includes at least one of the following modes.

For the purpose of improving reliability, the aggregation transmission modes may include at least one of the following: single frequency network (SFN) mode, wherein the UE1 and UE2 transmit the same data of the UE1 respectively, using the same encoding and modulation, and the same time-frequency resources; time division modulation (TDM) mode, wherein the UE1 and UE2 transmit the same data of the UE1, and use same/different encoding and modulation, and use time division resources; frequency division modulation (FDM) mode, wherein the UE1 and UE2 transmit the same data of the UE1, and use same/different encoding and modulation, and use frequency division resources; space division mode or code division mode, wherein the UE1 and UE2 transmit the same data of the UE1 but can use the same time-frequency resources with different beams or precoding.

For the purpose of improving throughput, the aggregation transmission modes includes at least one of the following: TDM mode, wherein the UE1 and UE2 transmit different data of the UE1 respectively; FDM mode, wherein the UE1 and UE2 transmit different data of the UE1; space division or code division mode, wherein the UE1 and UE2 transmit different data of the UE1.

In some implementations, the base station may also configure the information and resources required by an aggregation transmission mode to the paired UEs to achieve the transmission mode. In some implementations, the base station does not need to explicitly configure the aggregation transmission mode.

In some implementations, the UE1 may report the paired information to the base station and request the UE aggregation transmission mode, such as based on UE1's data transmission requirements. In some implementations, the UE2 may report the paired information to the base station and request the UE aggregation transmission mode. In some implementations, when the UE2 requests the UE aggregation transmission mode, the requested UE aggregation transmission mode is also notified by the UE1 to UE2. For example, the UE1 requests the UE aggregation transmission for reliability, or the UE1 requests the UE aggregation transmission for improving transmission throughput. After receiving the request, the base station may configure the corresponding UE aggregation transmission mode, or the base station may also configure the corresponding information and resources to implement the requested UE aggregation transmission mode.

In some implementations, the base station may configure the timing advance for UE aggregation transmission. For example, when the SFN mode is configured for UE aggregation transmission, the base station may configure the necessary timing advance for paired UEs for aggregation transmission of the UE1 and UE2.

In some implementations, for example, the base station notifies an offset of the timing advance based on the UE2 timing advance between the UE1 and UE2. For example, this offset is based on the timing of the UE2, and UE1 adjusts its own timing based on this offset, ultimately achieving timing synchronization between the UE1 and UE2. In some implementations, it may also be the timing advance for the base station to notify the UE1 and UE2 respectively. The UE1 and UE2 may adjust their respective timing based on the notified timing advance, ultimately achieving timing synchronization between UE1 and UE2.

In some implementations, the base station may configure power information for UE1 and UE2 for UE aggregation transmission.

In some implementations, the base station may configure the SFN mode for the paired UEs for UE aggregation transmission. Furthermore, for the SFN mode, the base station may configure the resources, the reference signal patterns in the resources and the cyclic prefixes of orthogonal frequency division multiplexing (OFDM) symbols in the resources. The UE1 and UE2 may perform the UE aggregation transmission in the configured resources, using the configured reference signal pattern and cyclic prefix. The reference signal pattern may be more dense; and/or the cyclic prefix may be longer.

The present disclosure describes other exemplary embodiments for reporting paired information and the relevant information. Specifically, a UE1 and a UE2 are paired, and the UE2 transmits the UE1's data to the base station. However, the base station is not aware that the data transmitted by the UE2 is UE1's data. The UE2 is equivalent to a “stealth helper” of the UE1, expanding UE1's capability for transmission. In some implementations, the above situation may be known as transparent mode.

In some implementations, the UE1 may report a paired information to the base station, which only indicates to the base station that UE1 has a paired UE for UE aggregation transmission, but the identification of the paired UE may not be included in the paired information. The identification of the UE that is paired with the UE1 is not notified to the base station. In this way, the base station can only know that the UE1 has a paired UE to assist in the transmission of the UE1 data.

In this case, with respect to the UE1 reporting the relevant information for UE aggregation transmission, the UE1 may report the relevant information of the UE2 to the base station through implicit means. In the reported relevant information, there is no need to identify the relevant information of the UE2. The relevant information of the UE2 may be integrated to be part of the relevant information of the UE1. In this way, after receiving the relevant information, the base station considers that it belongs to UE1, and schedules UE1's transmission based on the relevant information reported by the UE1.

For a non-limiting example, suppose the UE 1 can support up to 4 antenna ports for transmission, and the UE2 can support up to 4 antenna ports for transmission. When the UE1 reports the relevant information associated with UE's antenna ports to the base station, the UE1 may report that it can support up to 8 antenna ports for transmission, that is, the UE2's 4 antenna ports are used as the additional 4 antenna ports for the UE1. In this way, after receiving the relevant information related to the antenna ports reported by the UE1, the base station considers that UE1 can support up to 8 antenna ports for transmission; and the base station may schedule transmission for the UE1 based on 8 antenna ports.

When the base station schedules transmission for the UE1 based on 8 antenna ports, UE1 and UE2 may perform simultaneous transmission based on 4 antenna ports of the UE1 and 4 antenna ports of the UE2, respectively, thereby increasing UE1's transmission capacity through the UE2.

When the UE1 is configured with some CSI-RS resources for measurement by the base station, the CSI-RS resources may be configured based on the 8 antenna ports that contain the sum of antenna ports of the UE1 and antenna ports of the UE2. For example, 8 sets of CSI-RS resources are configured for the UE1, and the UE1 uses a portion of the configured 8 sets of CSI-RS resources (such as 4 sets of CSI-RS resources) to perform measurements and generate measurement results. In some implementations, the UE1 may notify the UE2 of the CSI-RS resource, which comes from the configured 8 sets of CSI-RS resources for UE1, for example, the remaining 4 sets of CSI-RS resources; and the UE2 uses the notified CSI-RS resource to perform measurements and generate measurement results.

In some implementations, the UE1 may obtain the measurement results of the UE2 through mutual interaction.

For a non-limiting example, the UE1 forms the final measurement result based on the measurement results of the UE1 and the measurement results of the UE2 and the configured 8 sets of CSI-RS resources. The measurement results of the UE1 and the measurement results of the UE2 are merged based on the configured 8 sets of CSI-RS resources to form the final measurement report, e.g., the index ascending or descending of the configured 8 sets of CSI-RS resources; and/or the UE1 reports the final measurement results to the base station.

In some implementations, the base station may schedule UE1's data (including uplink control information) based on the final measurement results. The UE1 may assign UE1's data to the UE2 based on the measurement results of the UE1 and the measurement results of the UE2 in the final measurement results. The UE2 transmits the assigned UE1's data based on the measurement results of the UE2 mentioned above. The UE1 transmits the remaining UE1's data based on the measurement results of the UE1 mentioned above.

In some implementations, the final measurement result may also serve as one of the relevant information mentioned above. In the above method of reporting the relevant information, the UE1 and/or the UE2 can report the final measurement results to the base station.

The present disclosure describes methods, apparatus, and computer-readable medium for wireless communication. The present disclosure addressed the issues with UE aggregation. The methods, devices, and computer-readable medium described in the present disclosure may facilitate the performance of wireless communication, thus improving efficiency and overall performance. The methods, devices, and computer-readable medium described in the present disclosure may improves the overall efficiency of the wireless communication systems.

In some other embodiments, a computer-readable medium comprising instructions which, when executed by a computer, cause the computer to carry out the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments, for non-limiting examples, a portion from one or more embodiment may be combined with another portion of other embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

What is claimed is:

1. A method for wireless communication, comprising:
determining user equipment (UE) aggregation transmission, wherein a first UE and a second UE are paired for the UE aggregation transmission, by:
reporting paired information to a base station; and
reporting relevant information to the base station.

2. A method for wireless communication, comprising:
configuring user equipment (UE) aggregation transmission, wherein a first UE and a second UE are paired for the UE aggregation transmission, by:
receiving paired information by a base station; and
receiving relevant information by the base station.

3. The method according to claim 1, wherein:
the second UE is determined to transmit the first UE's data to the base station, the first UE's data comprising uplink control information (UCI).

4. The method according to claim 1, wherein, the reporting the paired information to the base station comprises:
reporting, by the second UE, the paired information to the base station, the paired information comprising an identifier of the first UE, so that the base station is configured to determine that the second UE transmits the first UE's data to the base station.

5. The method according to claim 1, wherein, the reporting the paired information to the base station comprises:
reporting, by the first UE, the paired information to the base station, the paired information comprising an identifier of the second UE, so that the base station is configured to determine that the second UE transmits the first UE's data to the base station.

6. The method according to claim 1, wherein, the reporting the paired information to the base station comprises:
reporting, by each of the first UE and the second UE, the same paired information to the base station with same coding and same modulation in the same resource, the paired information comprising identifiers of the first UE and the second UE, so that the base station is configured to determine that the second UE transmits the first UE's data to the base station.

7. The method according to claim 1, wherein, the reporting the paired information to the base station comprises:
reporting, by at least one of the first UE and the second UE, the paired information to the base station configured by a signalling from the base station, the signaling comprising at least one of the following: a radio resource control (RRC) signalling or a medium access control (MAC) control element (CE).

8. The method according to claim 4, further comprising:
reporting, by at least one of the first UE and the second UE, a UE capability of reporting the paired information to the base station, so that the base station is configured to consider the UE having the UE capability to report the paired information.

9. The method according to claim 1, wherein:
the paired information comprises at least one of the following: an identification of the UE performing the UE aggregation transmission, or a role type of the UE performing the UE aggregation transmission.

10. The method according to claim 9, wherein:
the role type of the UE performing the UE aggregation transmission comprises at least one of the following: an anchor UE, an assistant UE, or a mutual UE;
wherein in response to the second UE being determined to transmit the first UE's data to the base station and the first UE being determined not to transmit the second UE's data to the base station, the first UE is the anchor UE and the second UE is the assistant UE; and
wherein in response to the second UE being determined to transmit the first UE's data to the base station, and the first UE also being determined to transmit the second UE's data to the base station, the first UE and the second UE are mutual UEs.

11. The method according to claim 1, wherein:
the paired information comprises at least one of the following: an identification of the UE performing the UE aggregation transmission, a role type of the UE performing the UE aggregation transmission, or an indication for anchor UE and assistant UE each other.

12. The method according to claim 1, wherein, the reporting the relevant information to the base station comprises:
reporting, by the second UE, the relevant information to the base station, the relevant information comprising information of the first UE and the second UE; or
reporting, by the first UE, the relevant information to the base station, the relevant information comprising information of the first UE and the second UE; or
reporting, by each of the first UE and the second UE, the same relevant information to the base station with same coding and same modulation in the same resource, so that the base station is configured to decode the relevant information; or
reporting, by each of the first UE and the second UE, different relevant information to the base station, so that the base station is configured to decode the relevant information from the received different relevant information; or
reporting, by at least one of the first UE and the second UE, the relevant information to the base station configured by a signalling from the base station, the signaling comprising at least one of the following: a radio resource control (RRC) signalling or a medium access control (MAC) control element (CE).

13-16. (canceled)

17. The method according to claim 12, further comprising:
reporting, by at least one of the first UE and the second UE, a UE capability of reporting the relevant information to the base station, so that the base station is configured to consider the UE having the UE capability to report the relevant information.

18. The method according to claim 1, wherein:
the relevant information comprises at least one of the following: a channel state information (CSI) report of the first UE, a CSI report of the second UE, a beam information of the first UE for transmission or reception, a beam information of the second UE for transmission or reception, a hybrid automatic repeat request acknowledgement (HARQ-ACK) information of the first UE, a HARQ-ACK information of the second UE, a UE aggregation transmission mode requested by the first UE, a UE aggregation transmission mode requested by the second UE, a multiple-input multiple-output (MIMO) information of the first UE for transmission or reception, a MIMO information of the second UE for transmission or reception, a measurement report of the first UE for interference, a measurement report of the second UE for interference, a measurement report of the first UE for adjacent cells, a measurement report of the second UE for adjacent cells, a measurement report of the first UE for adjacent frequencies, a measurement report of the second UE for adjacent frequencies, a measurement report of the first UE for same frequency, a measurement report of the second UE for same frequency, a measurement report of the first UE for reference signals received power (RSRP) or reference signals received quality (RSRQ), a measurement report of the second UE for RSRP or RSRQ, an antenna port information of the first UE for transmission or reception, or an antenna port information of the second UE for transmission or reception.

19. The method according to claim 1, wherein:
the base station configures at least one of the following: a mode of the UE aggregation transmission, or transmission information for the UE aggregation transmission having the mode.

20. The method according to claim 19, wherein:
the mode comprises at least one of the following: a single frequency network (SFN) mode, a time division modulation (TDM) mode, a frequency division modulation (FDM) mode, a space division mode, or a code division mode; and
the transmission information comprises at least one of the following: a timing advance for the UE aggregation transmission, an offset of the timing advance, or power information.

21. The method according to claim 1, wherein:
the first UE requests its mode of the UE aggregation transmission; or the second UE requests its mode of the UE aggregation transmission.

22. The method according to claim 1, wherein:
the reporting the paired information to the base station comprises:
reporting, by the first UE, the paired information to the base station, the paired information indicating the first UE being paired with other UE without an identifier of the other UE;
the reporting the relevant information to the base station comprises:
reporting, by the first UE, the relevant information to the base station, the relevant information comprising information of the first UE and information of the second UE; and
the base station is configured to schedule transmission of the first UE based on the relevant information.

23. A wireless communications apparatus, comprising a processor and a memory, wherein the processor is configured to read code from the memory and implement operations of:
determining user equipment (UE) aggregation transmission, wherein a first UE and a second UE are paired for the UE aggregation transmission, by:
reporting paired information to a base station; and
reporting relevant information to the base station.

24. A computer program product comprising a computer-readable program medium code stored thereupon, the computer-readable program medium code, when executed by a processor, causing the processor to implement a method recited in 1.
